(19) United States
(12) Patent Application Publication
(10) Pub. No.: US 2018/0094892 A1
(43) Pub. Date: Apr. 5, 2018

(54) GUN MOUNTING LOCK HAVING TWO PIVOTABLE ARMS

(71) Applicant: ESMET, INC., Canton, OH (US)

(72) Inventors: Timothy L. Bowe, JR., Canton, OH (US); Craig A. Pugh, Canton, OH (US); Michael E. Waryas, Canton, OH (US)

(73) Assignee: ESMET, INC.

(21) Appl. No.: 15/285,859

(22) Filed: Oct. 5, 2016

(51) Int. Cl. F41A 23/18; F41A 23/00; E05B 73/00; E05B 47/00; E05B 19/00; E05B 29/00

(52) U.S. Cl. CPC F41A 23/18; F41A 23/005; E05B 29/0013; E05B 47/0012; E05B 19/00; E05B 73/00

(57) ABSTRACT

A gun mounting lock and a method of using the same to secure a gun to a support surface. The gun mounting lock includes first and second arms positioned opposite each other and a ratchet assembly positioned between lower ends of the arms. The ratchet assembly engages gears provided on the lower ends of the arms. When the assembly is pushed downwardly by placing part of a gun thereon, the downward movement of the assembly causes the two arms to pivot towards each other simultaneously, capturing the gun between the arms and the assembly. The assembly is locked against movement in the reverse direction by a pin of a solenoid contacting a toothed flange on one of the arms. The assembly can be unlocked using a key or by providing power to the solenoid. The gun mounting lock housing is adjustably engaged with a track mounted on the support surface.

### BACKGROUND

### Technical Field

The present disclosure relates generally to devices for securing guns. More particularly, the present disclosure is directed to a gun mounting lock that is secured to a support surface and which captures part of a gun therein and securely retains the gun adjacent the support surface. Specifically, the invention is directed to a gun mounting lock having two arms and a plunger that is operatively engaged with the two arms; and wherein depressing the plunger (by placing part of a gun on the same) causes the arms to pivot towards each other into a closed position and thereby capture the part of the gun.

### Background Information

Gun safes, gun display racks and other types of support surfaces are typically provided with some type of gun mounting lock that serves a dual purpose. The gun mounting lock provides a way to physically mount the gun on support surface as well as securely locking the gun in place so that the gun may not be disengaged therefrom by unauthorized persons.

Gun mounting locks are typically configured to mount and secure a single specific type of gun or one or two specific types of guns. These types of gun mounting locks usually cannot secure other differently configured guns.

In many jurisdictions, police officers carry an AR-15 as well as a shotgun and because these are two quite differently configured weapons, a police cruiser may need to be provided with two different gun mounting locks to secure the individual weapons. This problem has been somewhat addressed in the art by providing gun mounting locks that may be capable of mounting and securing more than one type of gun therein.

U.S. Pat. No. 4,226,399 to Henderson, for example, discloses a lock that is designed to encircle a gun barrel. The lock includes two jaws that are mounted opposite each other on a housing. One of the jaws is rotatable while the other jaw may be fixed or rotatable. The lower end of each jaw may be provided with teeth that interlock with teeth on the opposing jaw so that the jaws move in synchrony with each other. A key is used to move the jaws to the open position. The disclosed gun mounting lock is designed to receive a barrel of a gun therein but the shape of the space between the jaws and the longitudinally elongate nature of the jaws may prevent certain types of weapons from being secured by this gun mounting lock.

U.S. Pat. No. 5,802,889 (Arnold) discloses a bicycle lock that includes a U-shaped housing that is fixedly engaged via a mounting to a portion of a support surface (in this instance, a bicycle frame). The housing bounds and defines a U-shaped space that is accessible through an entrance defined between two opposed free ends of the housing. A curved arm is received in a channel formed in one section of the housing and the arm is operatively engaged by way of a gear mechanism to a plunger. The interior surface of the housing opposite the entrance defines a hole therein and the plunger's shaft is received through that hole. The shaft is provided with teeth that mesh with a gear mechanism in the channel defined in the housing and thereby with the arm. When the plunger is depressed downwardly toward the bottom interior surface of the housing, the gear mechanism is actuated to move the curved arm out of an opening in one free end of the U-shaped housing. The arm is caused to move across the entrance and to engage in a lock on the opposed free end of the housing. The movement of the arm closes off access to housing through the entrance. If a gun barrel was placed on the plunger, the movement of the arm will secure the gun barrel between the plunger and the arm. When the lock is disengaged and the barrel is removed from the plunger, a spring in the plunger will cause the plunger to return to its non-depressed position and this movement will cause the arm to be slid back into the channel of the housing.

U.S. Pat. No. 5,934,112 (Rice et al) discloses a “handcuff” style gun mounting lock that has a base that is securable to a support surface. A C-shaped housing extends outwardly from the base and a swingable arm is pivotally engaged with an upper end of the housing. The arm has ratchet teeth formed on an exterior surface thereof. When the arm is pivoted to engage the housing; the ratchet teeth interlock with a ratchet assembly provided on the housing. A key must be employed to disengage the ratchet teeth from the ratchet assembly to unlock the gun mounting lock and release a gun barrel captured in a space defined between the housing and the arm.

U.S. Pat. No. 7,047,771 (Tanos) and U.S. Pat. No. 8,991,224 (Zalavari) disclose “handcuff style” gun mounting locks. These locks have a fixed C-shaped housing with a swingable arm that is pivotally engaged to one end of the housing. The arm is pivotable in a first direction to permit access to a C-shaped recess defined by the housing; and is pivotable in a second direction to block access to the C-shaped recess. When the arm is pivoted in the second direction, the arm's free end moves into a channel defined in the housing and is locked to the housing by a suitable locking mechanism. These patents disclose that the locking mechanism may be a ratchet type lock where a plurality of teeth are provided on a surface of the arm and these teeth engage a ratchet latch on the housing. The ratchet latch may be activated by a solenoid or by a key.

Bleazard (U.S. Pat. No. 8,794,454) discloses a bicycle lock that includes a pair of locking arms that are mounting to pivot toward each other to capture part of a bicycle frame between them. The locking arms pivot away from each other to release the part of the bicycle frame. Each arm is generally C-shaped and the lower ends thereof curve upwardly into a space defined by the opposed arms. The part of the bicycle frame is rested on these lower ends and depressing the lower ends downwardly causes the arms to pivot about pivot rods spaced a distance outwardly from the lower ends. The pivotal motion generated by depressing the lower ends of the arms causes the upper ends of those arms to rotate towards each other. A locking mechanism is provided to prevent the arms from accidentally rotating away from each other.

### SUMMARY

While the prior art discloses a number of weapon mounting systems that include gun mounting locks that are able to secure more than one type of gun, there remains a need in the art for a gun mounting lock that is able to mount and secure a wider range of gun types therein. The gun mounting lock disclosed herein addresses some of the short-comings of the prior art.

A gun mounting lock and a method of using the same to secure a gun to a support surface are disclosed herein. The gun mounting lock includes first and second arms positioned opposite each other and a ratchet assembly positioned between lower ends of the arms. The ratchet assembly engages gears provided on the lower ends of the arms. When the assembly is pushed downwardly by placing part of a gun thereon, the downward movement of the assembly causes the two arms to pivot towards each other simultaneously, capturing the gun between the arms and the assembly. The assembly is locked against movement in the reverse direction by a pin of a solenoid contacting a toothed flange on one of the arms. The assembly can be unlocked using a key or by providing power to the solenoid. The gun mounting lock housing is adjustably engaged with a track mounted on the support surface.

In one aspect, a gun mounting lock may comprise a housing; a first arm rotatably mounted on the housing; a second arm rotatably mounted on the housing; wherein the first arm is opposed to the second arm; a ratchet assembly provided on the housing; said ratchet assembly being operatively engaged with both of the first arm and the second arm; wherein the ratchet assembly is movable relative to the housing and when the ratchet assembly is moved in a first direction the first and second arms pivot in unison towards each other; and when the ratchet assembly is moved in a second direction the first and second arms pivot in unison away from each other.

In another aspect, a gun mounting lock may comprise a first arm; a second arm positioned opposite the first arm; a plunger positioned between a lower end of the first arm and a lower end of the second arm; said plunger being operatively engaged with the lower ends of each of the first and second arms; wherein the plunger is movable in a first direction or a second direction; and when the plunger is moved in the first direction, an outer end of the first arm and an outer end of the second arm are caused to move towards each other; and when the plunger is moved in the second direction, the outer ends of the first and second arms move away from each other. The plunger moves linearly in the first direction and in the second direction; and wherein the linear motion of the plunger is translated to rotational motion of the first and second arms. The plunger may be a ratchet assembly comprising a base having a first side located opposite the lower end of the first arm; and a second side that is located opposite the lower end of the second arm; wherein each of the first and second sides includes one or more ratchet teeth; and wherein the one or more ratchet teeth on the first side operatively engage a first gear on the first arm; and the one or more ratchet teeth on the second side operatively engage a second gear on the second arm. The first and second gears may be integrally formed as part of the first arm and the second arm, respectively.

In another aspect, a method of using a gun mounting lock to secure a gun to a support surface may comprise providing a gun mounting lock comprising a first arm; a second arm positioned opposite the first arm; and a plunger positioned between and operatively engaged with a lower end of the first arm and a lower end of the second arm; placing a part of the gun onto an upper surface of the plunger; applying a downward force on the upper surface of the plunger; moving the plunger downwardly; translating the downward motion of the plunger into rotational motion of the lower ends of the first arm and the second arm; rotating the lower end of the first arm about a first axis; rotating the lower end of the second arm about a second axis; pivoting an upper end of the first arm towards an upper end of the second arm; pivoting the upper end of the second arm toward the upper end of the second arm; and capturing the part of the gun between the upper ends of the first and second arms and the upper surface of the plunger.

### BRIEF DESCRIPTION OF THE SEVERAL VIEWS OF THE DRAWINGS

A sample embodiment is set forth in the following description, is shown in the drawings and is particularly and distinctly pointed out and set forth in the appended claims.

FIG. 1 is a left side elevation view of a gun mounting lock retaining a gun therein;

FIG. 2 is a front elevation view of the gun mounting lock shown in the open position taken along line 2-2 of FIG. 1;

FIG. 3 is a top plan view of the gun mounting lock shown engaged on a track;

FIG. 4 is a bottom plan view of the gun mounting lock of FIG. 3 with the track and padding removed for clarity;

FIG. 5 is an enlarged left side elevation view of the gun mounting lock shown in the open position;

FIG. 6 is a left side isometric perspective view of the gun mounting lock shown in the open position;

FIG. 7 is an exploded perspective view of the housing of the gun mounting lock with some components omitted for clarity;

FIG. 8 is an enlarged perspective view of the right locking arm of the gun mounting lock shown alone;

FIG. 9 is a front elevation view of the right locking arm of FIG. 8;

FIG. 10 is an enlarged isometric perspective view of the left locking arm of the gun mounting lock shown alone;

FIG. 11 is a perspective view of the left locking arm of FIG. 10 shown from a different angle;

FIG. 12 is a front elevation view of the left locking arm of FIG. 10;

FIG. 13 is an enlarged front left isometric perspective view of the ratchet assembly shown alone;

FIG. 14 is an enlarged front right isometric perspective view of the ratchet assembly of FIG. 13;

FIG. 15 is a front elevation view of the ratchet assembly of FIG. 13;

FIG. 16 is a bottom plan view of the ratchet assembly of FIG. 13;

FIG. 17 is a right side elevation view of the ratchet assembly of FIG. 13;

FIG. 18 is a partial cross-section of the right locking arm taken along line 18-18 of FIG. 2 and with the power pack and some of the wiring omitted for clarity;

FIG. 19 is a partial cross-section of the right locking arm taken along line 19-19 of FIG. 2;

FIG. 20 is a front elevation view of the gun mounting lock in the open position with the second housing section removed and with the ratchet assembly partially broken away, and showing a gun barrel supported on the ratchet assembly;

FIG. 21 is a front elevation view of the gun mounting lock in the closed position with the second housing section removed and with the ratchet assembly partially broken away and showing a gun barrel supported on the ratchet assembly and secured in place by the first and second arms;

FIG. 22 is a rear view of a barrel lock taken along line 22-22 of FIG. 21;

FIG. 23 is a front elevation FIG. 20 is a front elevation view of the gun mounting lock with a front half of the housing removed and showing a gun barrel being removed from the ratchet assembly and the gun mounting lock shown moving from the closed position to the open position; and

FIG. 24 is a rear view of the barrel lock taken along line 24-24 of FIG. 23.

Similar numbers refer to similar parts throughout the drawings.

### DETAILED DESCRIPTION

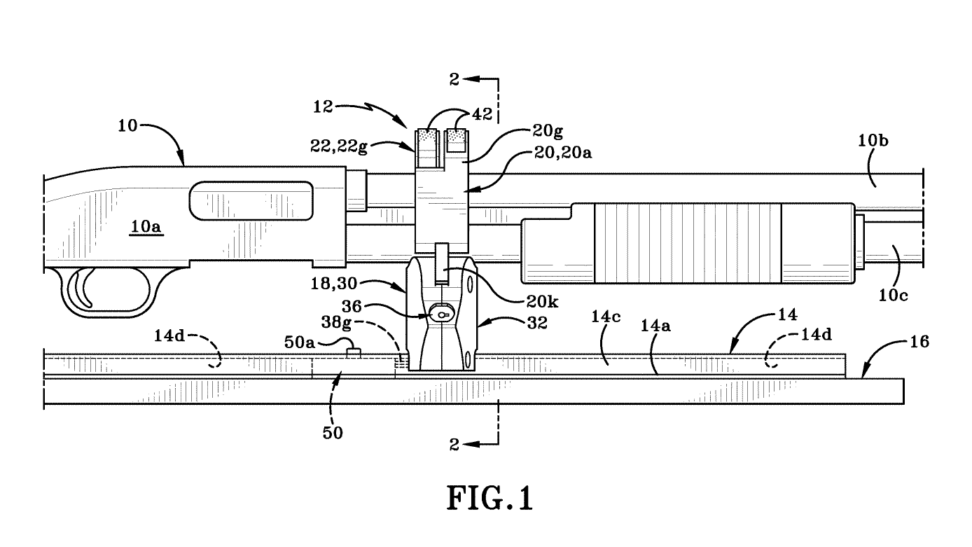

Referring to FIG. 1 there is shown a gun 10 secured by way of a gun mounting lock 12 and a track 14 in accordance with an aspect of the present invention to a support surface 16. Gun 10 may include a stock 10a and one or more barrels, such as barrels 10b, 10c, that extend outwardly and forwardly from stock 10a. FIG. 1 shows barrels 10b, 10c engaged and retained by gun mounting lock 12. It will be understood that one or more substantially identical gun mounting locks 12 may be utilized to secure gun 10 to track 14. Track 14 may be fixedly engaged to a support surface 16 such as an interior roof frame of a police cruiser or to a wall of a gun safe or a display rack. FIG. 1 shows gun mounting lock 12 holding gun 10 in a position above a horizontally oriented track 14. It will be understood that track 14 and gun mounting lock 12 may be oriented to suspend gun 10 below support surface 16. Furthermore, track 14 may be mounted on a vertically oriented support surface 16 or on an inclined support surface 16 and gun mounting lock 12 will secure gun in an orientation that is generally parallel to the support surface 16.

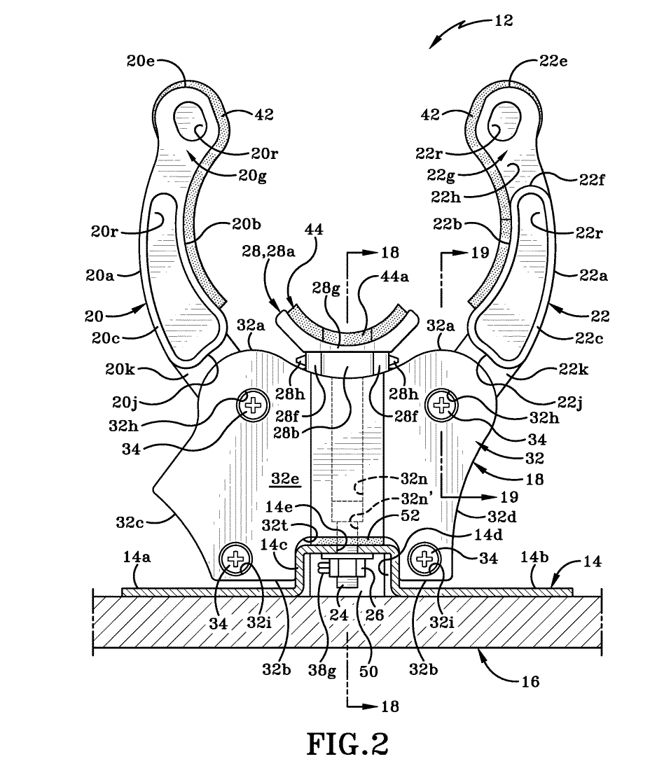

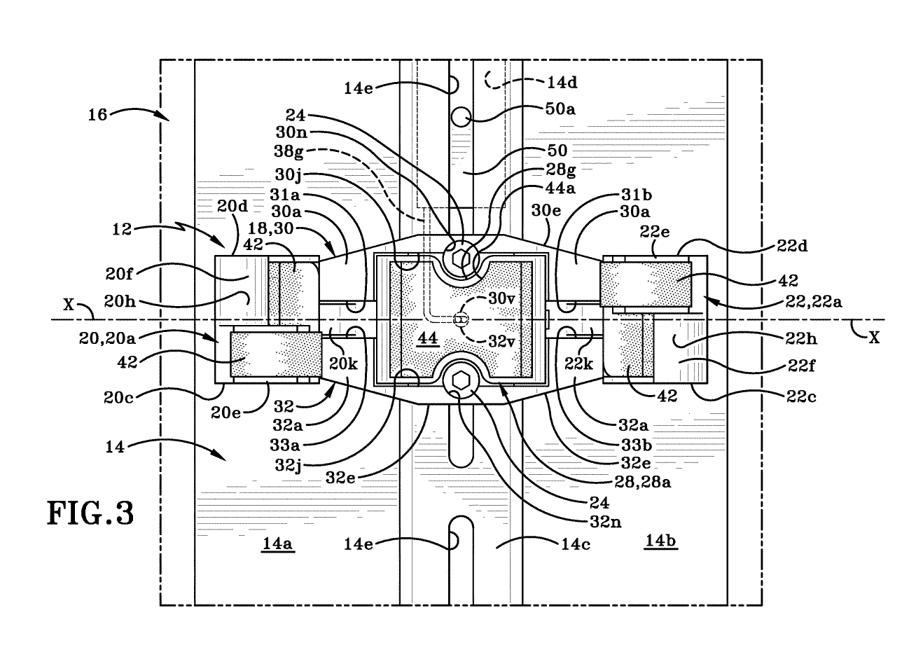

As shown in FIGS. 2 and 3, track 14 may comprise an elongate metal bar having a first side section 14a, a second side section 14b and a central U-shaped projection 14c that extends upwardly and outwardly beyond the upper surfaces of first and second side sections 14a, 14b. Projection 14c may run for substantially the entire length of track 14 from a first end thereof to a second end thereof. The upper surfaces of first side section 14a and second side section may be substantially aligned with each other. The lower surfaces of first side section 14a and second side section 14b may be substantially aligned with each other and abut an outer surface of support surface 16. A cavity 14d is defined by U-shaped projection 14c. A plurality of longitudinally-elongate slots 14e may be defined in a central region of projection 14c and slots 14e may be in communication with cavity 14d. Slots 14e may be used to secure gun mounting lock 12 to track 14 (as will be described hereafter) and the elongate nature of slots 14e provides for adjustable positioning of gun mounting lock 12 on track 14. It will be understood that track 14 may be secured to support surface 16 in any suitable manner such as by way of a plurality of fasteners, by welding or by an adhesive.

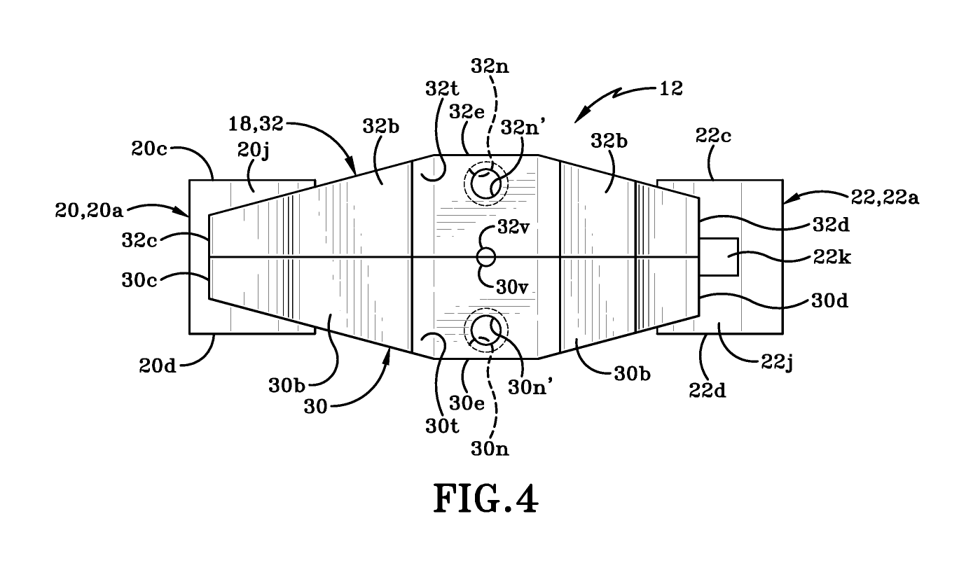

Referring to FIGS. 2-7, gun mounting lock 12 may include a housing 18, a first arm 20 and a second arm 22. Housing 18 may be secured to track 14 by way of mounting screws 24 that are inserted through slots 14e and nuts 26 that lock mounting screws 24 to track 14, as will be described further herein. Gun mounting lock 12 may further comprises a control arm 28 that is operatively engaged with each of first and second arms 20, 22. Control arm 28 may control the pivotal motion of first and second arms 20, 22 toward each other and/or away from each other. The control arm may take the form of a plunger that is operatively engaged with first and second arms 20, 22. The plunger may be located centrally between the lower ends of first and second arms 20, 22 and be operatively engaged with the lower ends. When the plunger is moved linearly in a first direction relative to an outer wall of housing 18, first and second arms 20, 22 pivot towards each other. When the plunger is moved linearly in a second direction relative to the outer wall of housing 18, first and second arms 20, 22 pivot away from each other. (In other instances, if the first and second arms 20, 22 pivot away from each other, the plunger may be moved by its engagement with the lower ends of first and second arms 20, 22 in a second direction relative to the outer wall of the housing 18.) In some instances, when the plunger is depressed inwardly towards an outer wall of the housing 18, first and second arms 20, 22 pivot towards each other and close around a gun barrel.

The plunger may take the form of a ratchet assembly that is positioned between the lower ends of first and second arms 20, 22 and is able to move upwardly and downwardly relative to the outer wall of housing 18. The ratchet assembly 18 may include teeth that mesh with teeth on gears provided on each of first and second arms 20, 22. As will be described later herein, the gears may take the form of mounting hubs that are integrally molded as part of the body of the first arm 20 or the second arm 22. Although not illustrated herein, it will be understood that in other instances separate gears may be fixedly mounted to lower ends of the first and second arms 20, 22. The linear movement of ratchet assembly 28 is translated into pivotal motion of first and second arms 20, 22 and vice versa. The control arm will be referred to in the following description by the term “ratchet assembly 28” but it should be understood that the terms “control arm”, “plunger” and “ratchet assembly” may be used interchangeably.

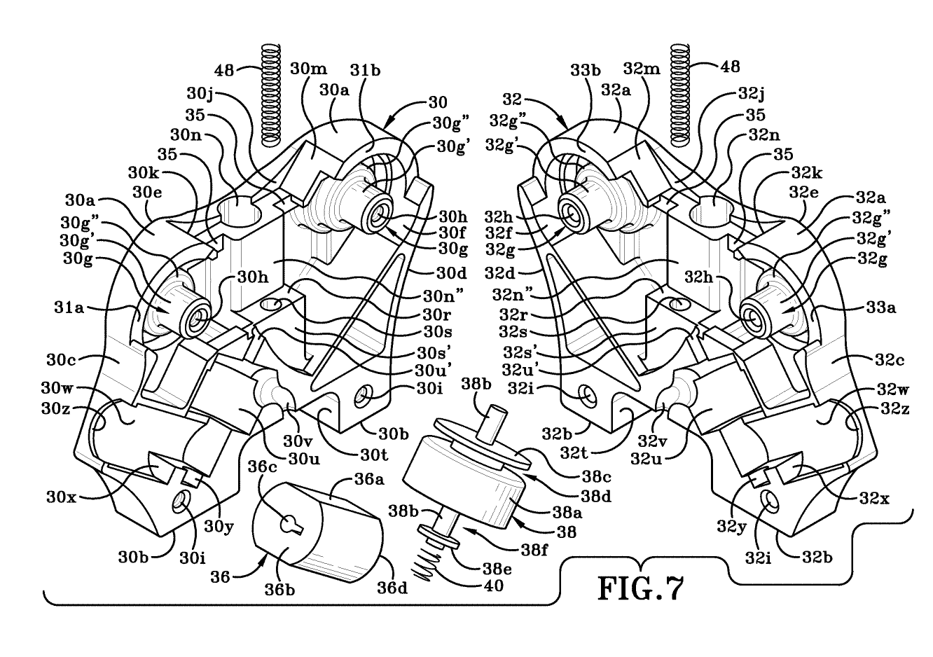

Housing 18 may comprise a first housing section 30 and a second housing section 32. Each of the first and second housing sections 30, 32 may be molded components that may be formed in any desired shape, such as the shapes illustrated in FIG. 7. First and second housing sections 30, 32 are configured to be complementary to each other and to be secured to each other by fasteners 34 or by any other suitable means. It should be understood that each of the first and second housing sections 30, 32 is molded to form partial walls, projections, recesses, apertures, channels etc. that, when the housing sections 30, 32 are engaged with each other, will form complete walls, projections, recesses, apertures, channels etc. for the various internal components of gun mounting lock 12.

Preferably, first and second arms 20, 22, ratchet assembly 28 and first and second housing sections may be fabricated from a strong material such as a metal so that it is difficult for an unauthorized person to damage or break the same in order to release a gun from gun mounting lock 12.

First housing section 30 may comprise a top wall 30a, a bottom wall 30b, a first side wall 30c, a second side wall 30d, and an end wall 30e. The walls 30a-30e bound and define a cavity 30f. (It will be understood that the terms top, bottom, upper, lower, upward, downwardly, front, back, etc. are used herein to describe relationships between components of gun mounting lock 12 as illustrated in the attached figures. These terms should not be construed to describe an orientation in which the gun mounting lock 12 or the components thereof have to be arranged.)

A pair of hubs 30g extends outwardly from an interior surface of end wall 30e, a short distance downwardly from top wall 30a. A first one of the hubs 30g is located proximate first side wall 30c and the second one of the hubs 30g is located proximate second side wall 30d. Hubs 30g may be oriented generally at right angles to the interior surface of end wall 30e. Each hub 30g comprises a first hub section 30g′ that is of a first diameter and a second hub section 30g″ that is of a second diameter, where the second diameter is greater than the first diameter. First hub 30g also defines an aperture 30h therein that is threaded and extends for a distance inwardly into one or both of the first hub section 30g′ and 30g″.

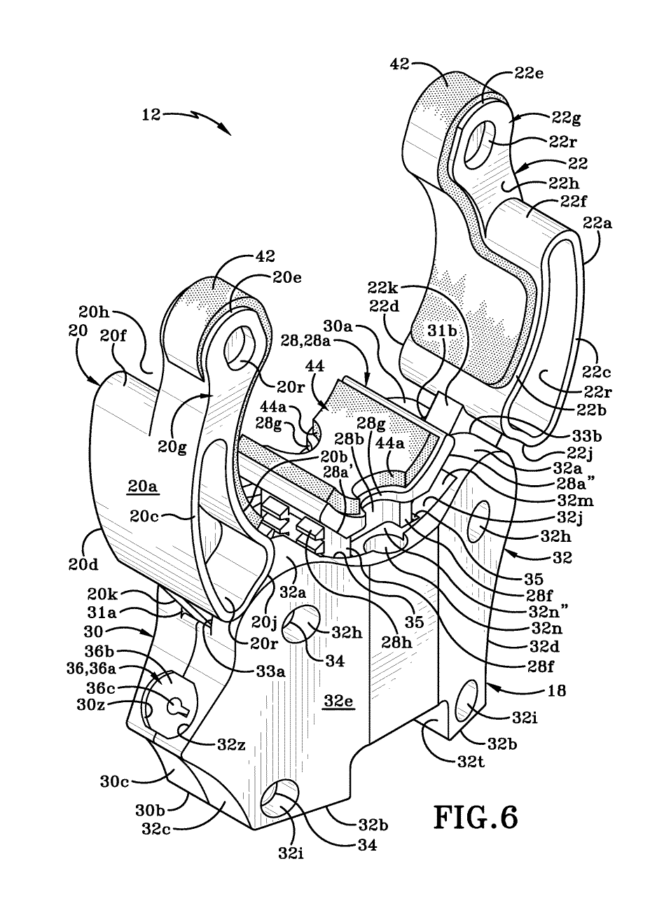

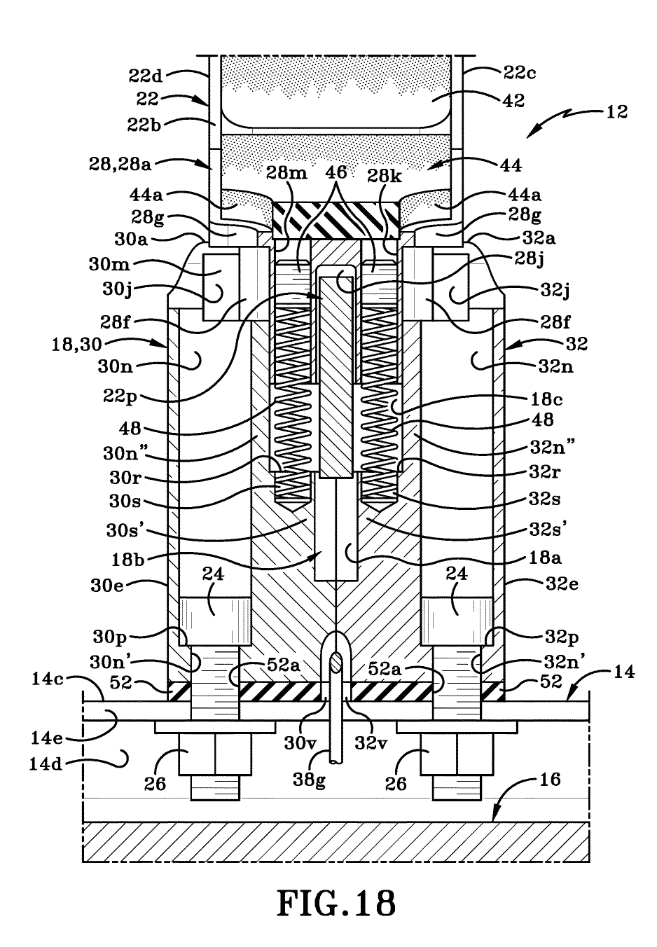

A threaded first aperture 30i and a threaded second aperture 30i may defined in end wall 30e proximate bottom wall 30b; each of the apertures 30i may be located proximate one or the other of first side wall 30c and second side wall 30d. Top wall 30a may define a recessed region 30j therein with a first angled surface 30k and a second angled surface 30m being provided at opposed ends of the recessed region 30j. A hole 30n may be defined partially in top wall 30a and partially in an upper surface of recessed region 30j of top wall 30a. Hole 30n, as shown in FIG. 18, may extend all the way through an enlarged U-shaped projection 30n″ formed on first housing section 30, through to a shoulder 30p that is spaced a distance upwardly from bottom wall 30b. Vertically oriented slots 35 (FIGS. 6 and 7) are formed on either side of the U-shaped projection 30n″ and these slots 35 open into the recessed region 30j and extend downwardly on either side of projection 30n″ and are oriented generally parallel to hole 30n.

From shoulder 30p to an opening in bottom wall 30b, first hole 30n may narrow in diameter, thereby becoming hole 30n′ that is accessible through an opening in bottom wall 30b.

A second projection 30s′ is formed on first housing section 30 and extends for a distance further outwardly and forwardly away from end wall 30e than does projection 30n″. A ledge 30r is located on an upper surface of projection 30s′ a distance downwardly from recessed region 30j. An aperture 30s may be defined through projection 30s′; with aperture 30s originating in ledge 30r and extending downwardly for a distance, terminating a short distance below ledge 30r. Aperture 30s may be oriented substantially parallel to hole 30n.

Bottom wall 30b of first housing section 30 may define a depression 30t therein. Depression 30t may be substantially U-shaped when viewed from the front and may be configured to receive a portion of the U-shaped projection 14c of track 14 therein (as may be seen in FIG. 2).

First housing section 30 is also molded to define a solenoid support chamber 30u and a channel 30u′ that is in communication with solenoid support chamber 30u. Channel 30u′ extends outwardly from chamber 30u and towards projection 30n″ and second projection 30s′. First housing section 30 also defines a groove 30v that is in communication with chamber 30u and extends downwardly therefrom and terminates in an opening in depression 30t.

First housing section 30 also defines a barrel lock chamber 30w. A projection 30x extends outwardly from barrel lock chamber 30w and a notch 30y is defined in projection 30x. A C-shaped opening 30z is defined in first side wall 30c of first housing section 30 and is in communication with barrel lock chamber 30w. Opening 30z provides part of an entrance into barrel lock chamber 30w.

FIG. 7 also shows that a first notch 31a is defined partially in top wall 30a and first side wall 30c of first housing section 30; and that a second notch 31b is defined partially in top wall 30a and second side wall 30d of first housing section 30.

Second housing section 32 may comprise a top wall 32a, a bottom wall 32b, a first side wall 32c, a second side wall 32d, and an end wall 32e. The walls 32a-32e bound and define a cavity 32f. A pair of hubs 32g extends outwardly from an interior surface of end wall 32e, a short distance downwardly from top wall 32a. A first one of the hubs 32g is located proximate first side wall 32c and the second one of the hubs 32g is located proximate second side wall 32d. Hubs 32g may be oriented generally at right angles to the interior surface of end wall 32e. Each hub 32g comprises a first hub section 32g′ that is of a first diameter and a second hub section 32g″ that is of a second diameter, where the second diameter is greater than the first diameter. First hub 32g also defines an aperture 32h therein that may be unthreaded and extends for a distance inwardly into one or both of the first hub section 32g′ and 32g″.

A first aperture 32i and a second aperture 32i may defined in end wall 32e proximate bottom wall 32b; each of the apertures 32i may be located proximate one or the other of first side wall 32c and second side wall 32d. Top wall 32a may define a recessed region 32j therein with a first angled surface 32k and a second angled surface 32m being provided at opposed ends of the recessed region 32j. A hole 32n may be defined partially in top wall 32a and partially in an upper surface of recessed region 32j of top wall 32a. Hole 32n, as shown in FIG. 18, may extend all the way through an enlarged U-shaped projection 32n″ formed on second housing section 32, through to a shoulder 32p that is spaced a distance upwardly from bottom wall 32b. Vertically oriented slots 35 (FIGS. 6 and 7) are formed on either side of the U-shaped projection 32n″ and these slots 35 open into the recessed region 32j and extend downwardly on either side of projection 32n″ and are oriented generally parallel to hole 32n.

From shoulder 32p to an opening in bottom wall 32b, first hole 32n may narrow in diameter, thereby becoming hole 32n′ that is accessible through an opening in bottom wall 32b.

A second projection 32s′ is formed on second housing section 32 and extends for a distance further outwardly and forwardly away from end wall 32e than does projection 32n″. A ledge 32r is located on an upper surface of projection 32s′ a distance downwardly from recessed region 32j. An aperture 32s may be defined through projection 32s′; with aperture 32s originating in ledge 32r and extending downwardly for a distance, terminating a short distance below ledge 32r. Aperture 32s may be oriented substantially parallel to hole 32n.

Bottom wall 32b of second housing section 32 may define a depression 32t therein. Depression 32t may be substantially U-shaped when viewed from the front and may be configured to receive a portion of the U-shaped projection 14c of track 14 therein (as may be seen in FIG. 2).

Second housing section 32 is also molded to define a solenoid support chamber 32u and a channel 32u′ that is in communication with solenoid support chamber 32u. Channel 32u′ extends outwardly from chamber 32u and towards projection 32n″ and second projection 32s′. Second housing section 32 also defines a groove 32v that is in communication with chamber 32u and extends downwardly therefrom and terminates in an opening in depression 32t.

Second housing section 32 also defines a barrel lock chamber 32w. A projection 32x extends outwardly from barrel lock chamber 32w and a notch 32y is defined in projection 32x. A C-shaped opening 32z is defined in first side wall 32c of second housing section 32 and is in communication with barrel lock chamber 32w. Opening 32z provides part of an entrance into barrel lock chamber 32w.

FIG. 7 also shows that a first notch 31a is defined partially in top wall 32a and first side wall 32c of second housing section 32; and that a second notch 31b is defined partially in top wall 32a and second side wall 32d of second housing section 32.

When first and second housing sections 30, 32 are engaged with each other, hubs 30g are aligned with hubs 32g, holes 30h are aligned with holes 32h; and holes 30i are aligned with holes 32i. Fasteners 34 (FIG. 2) are inserted through aligned holes 32h and 32i and are screwed into engagement with the threads of holes 30h and 30i. Furthermore, when first and second housing sections 30, 32 are engaged, the cavities 30f, 32f defined by the respective housing sections 30, 32 form the interior space of housing 18 within which various other components are received. The C-shaped sections 30z, 32z form an opening in a first side of housing 18; notches 31a, 33a form a first slot in the first side of housing 18; while notches 31b, 33b form a second slot in a second side of housing 18.

FIGS. 7, 18 and 20 show that a barrel lock 36 and a solenoid 38 are received within the interior space defined by housing 18. Barrel lock 36 is seated in barrel lock chamber 30w, 32w and is provided are one mechanism for unlocking gun mounting lock 12. Solenoid 38 is seated in solenoid chamber 30u, 32u and is provided as another mechanism for unlocking gun mounting lock 12. (In other instances, barrel lock 36 and/or solenoid 38 may be provided as mechanisms for locking gun mounting lock 12 as will be described later herein.)

Barrel lock 36 may include a body 36a having a front face 36b that defines a keyhole slot 36c therein. (Barrel locks 36 are known in the art and therefore the specifics of the locking mechanism provided therein will not be further described herein.) Front face 36b of barrel lock 36 is accessible through the opening in the first side of the housing 18 defined by the two C-shaped recesses 30z, 32z that are defined in first side walls 30c and 32c of first and second housing sections 30, 32. Body 36a also includes a rear face 36d and a detent 36e extends outwardly for a distance from rear face 36d. Detent 36e includes a leg 36f that is oriented substantially at right angles to rear face 36d of body 36a. Detent 36e and therefore leg 36f are selectively rotatable when a key is inserted into slot 36c and is turned to unlock or lock the gun mounting lock 12.

Solenoid 38 may include a generally cylindrical body 38a, a pin 38b extending outwardly from each of the first and second end surfaces of body 38a; a first plate 38c that is located on pin 38b adjacent a first end surface of body 38a and is separated therefrom by a gap 38d; and a second plate 38e that is separated from the second end surface of body 38a by a space 38f. Pin 38b has an upper terminal end 38h. Body 38a is seated within solenoid support chamber 30u, 32u′ while at least a first part of pin 38b is seated in channel 30u′, 32u′. Channel 30u′, 32u′ supports pin 38b and provides a path for pin 38b to move along. Wiring 38g (FIGS. 1, 3 and 18 extends outwardly from body 38a and is fed through channel 30v, 32v and connects solenoid 38 to a power pack 50 that may be mounted in the cavity 14d defined of track 14. Power pack 50 may be provided with an actuator 50a (FIG. 1) that can be used to switch power to solenoid 38 on or off, as will be later described herein. It will be understood that actuator 50a may be provided on power pack 50 as shown in FIG. 1 or the actuator may be provided on housing 18. Actuator 50a may take any suitable form such as a button, a keypad, a fingerprint pad, a retinal scanner, a voice activator or any type of direct or remote activation means that enables a user to provide power to solenoid 38 or to cut power to solenoid 38.

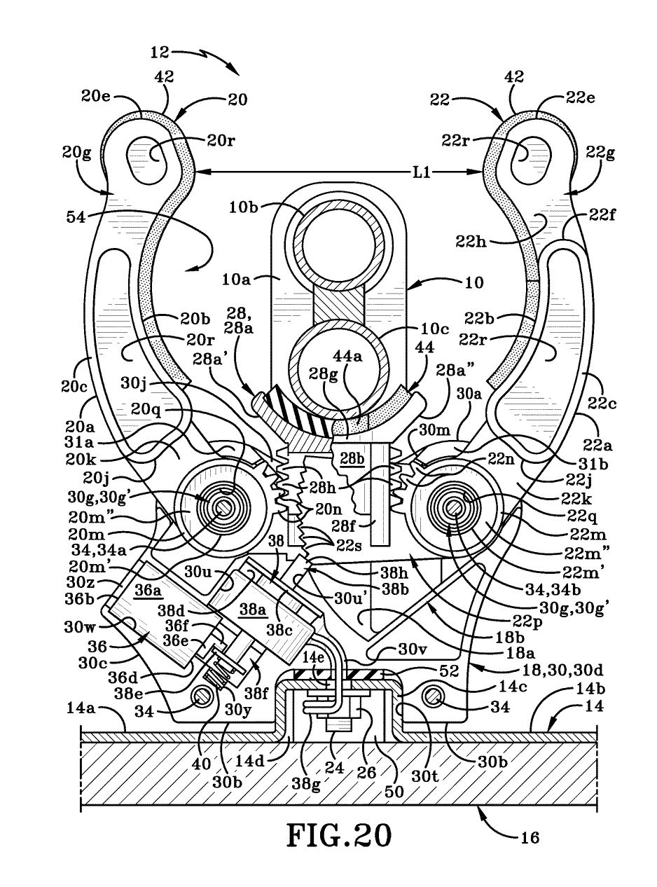

A coil spring 40 surrounds a lower portion of pin 38b that extends outwardly from second plate 38e. Spring 40 and the lower portion of pin 38b are received in a depression (FIG. 20) defined partially by notch 30y in the interior surface of first housing section 30 and partially by notch 32y in the interior surface of second housing section 32. Spring 40 is provided to urge pin 38b upwardly in a direction away from bottom wall 30b, 32b of housing 18.

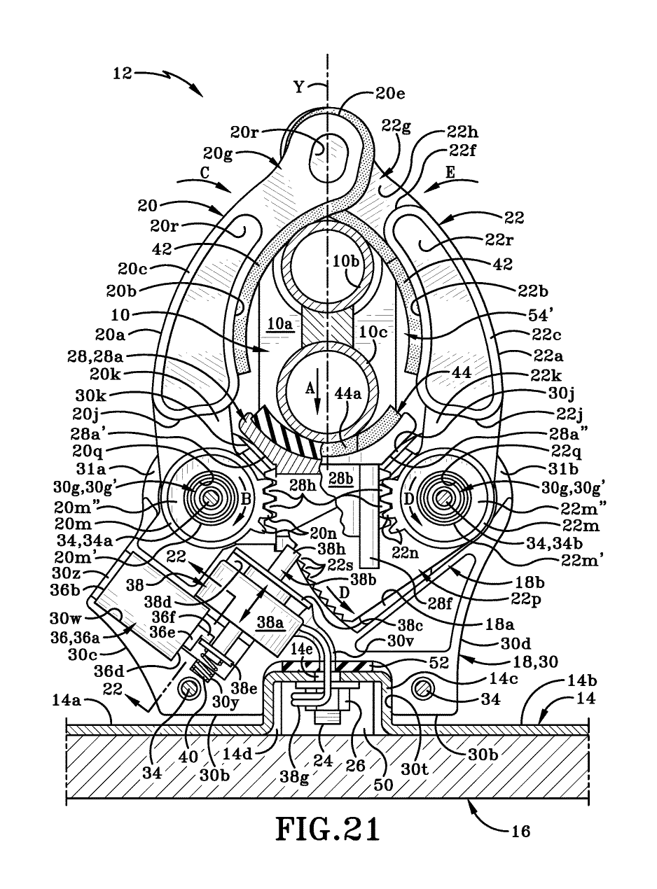

As indicated earlier herein, gun mounting lock 12 includes first arm 20 and second arm 22. These arms 20, 22 have first ends that are seated within the interior cavity of housing 18. The arms 20, 22 are mounted to housing 18 in a clam-shell type arrangement where they are opposed to each other and are able to pivot between an open position (shown in FIG. 2) and a closed position (shown in FIG. 21).

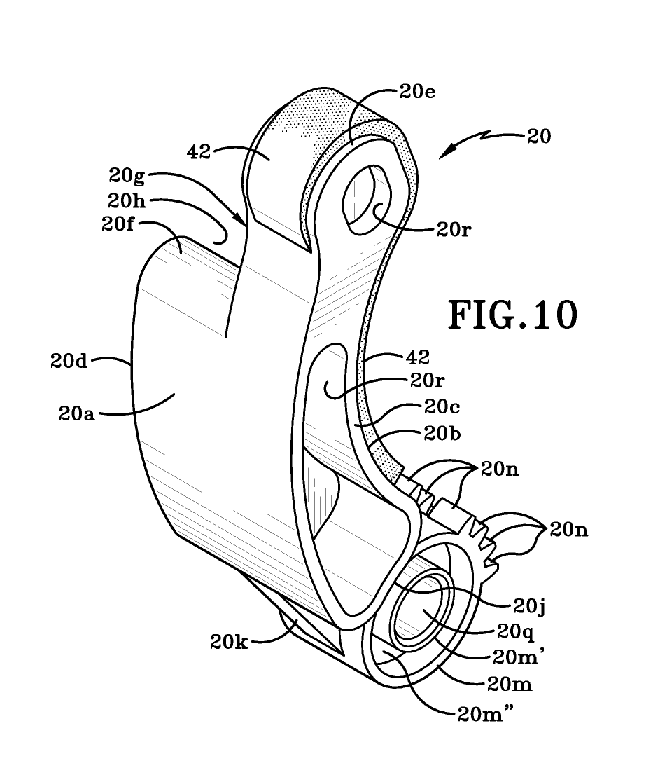

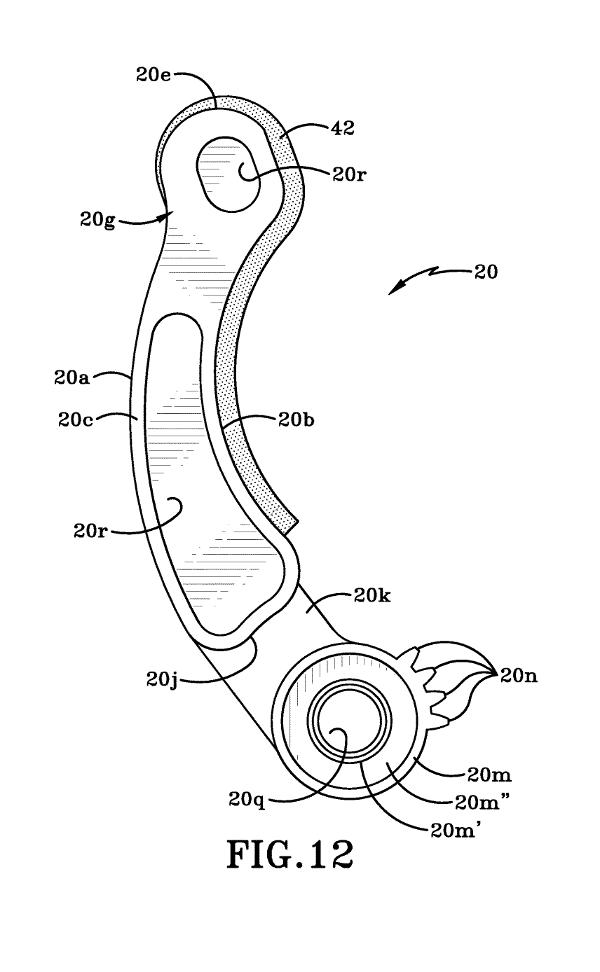

First arm 20 is shown by itself in FIGS. 10-12. First arm 20 comprises a body that is generally C-shaped (FIG. 12) when viewed from the front. First arm 20 has an exterior wall 20a, an interior wall 20b, a front end 20c, and a rear end 20d. First arm 20 also includes an upper end comprising a first upper wall 20e and a second upper wall 20f; where the second upper wall 20f is located a distance downwardly from first upper wall 20e. The effect of this is that the free end of first arm 20 forms a projection 20g that extends upwardly and outwardly for a distance beyond second upper wall 20f. A notch 20h is defined laterally adjacent projection 20g. It should be noted that notch 20h is located proximate rear end 20d and remote from front end 20c.

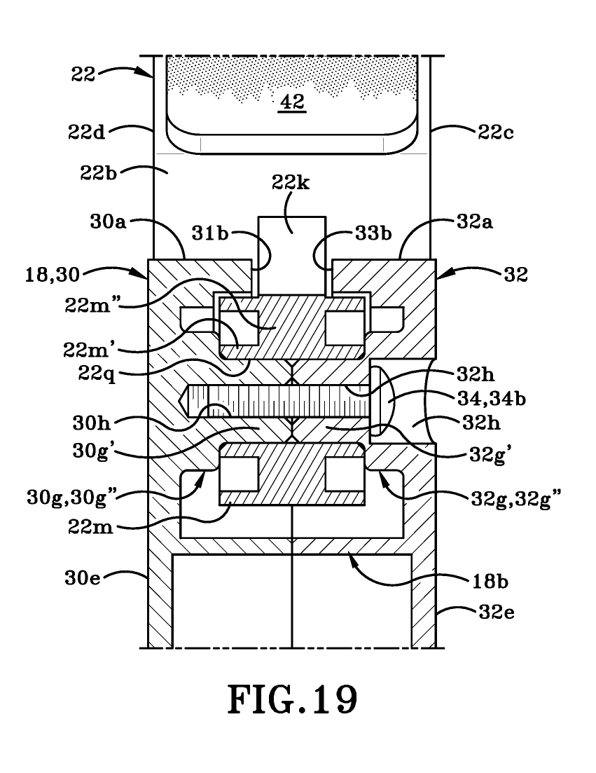

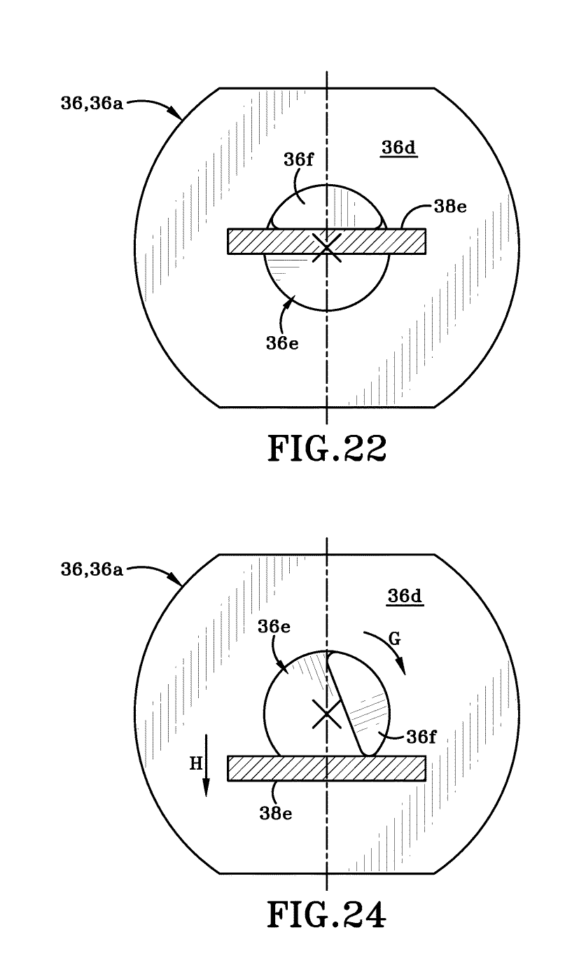

First arm 20 has a lower end that includes lower wall 20j and may have a flange 20k which extends outwardly from lower wall 20j. A hub 20m may be provided at an end of flange 20k. Hub 20m may have a generally circular exterior wall upon which is provided at least one tooth 20n. Hub 20m may, instead have a row of teeth 20n or may have two or more rows of teeth 20n. If two or more rows are provided, then adjacent rows are spaced laterally apart from each other by a gap 20p. The rows of teeth 20n may be provided on that part of hub 20m that faces in the same general direction as interior wall 20b. A smaller diameter hub section 20m′ may be located centrally within the exterior wall of hub 20m and be separated from the exterior wall by an annular ring 20m″. The exterior wall of hub 20m and the hub section 20m′ may be concentric. Hub section 20m′ may define a through-hole 20q that extends from front end 20c through to rear end 20d of first arm 20. Hole 20q is sized to receive one of the hubs 30g of first housing section 30 and one of the hubs 30h of second housing section 32 therethrough, as is illustrated in FIGS. 19 and 22. The selected hubs 30g and 32g are positioned so that the apertures 30h and 32h therein are aligned with each other. A fastener 34 is inserted into hole 32h from an exterior surface of end wall 32b and into the threaded hole 30h in first housing section 30. Fastener 34 secures first and second housing sections 30, 32 together and also acts as part of a pivot rod around which first arm 20 may pivot. First arm 20 is configured to pivot about a longitudinal axis of the shaft of fastener 34. When first arm 20 is engaged within housing 18, flange 20k extends outwardly through the slot in housing 18 that is defined by notches 31a and 33a. This is shown in FIG. 6. The upper end of first arm 20 (including projection 20g is located outside of housing 18 and mounting hub 20m is located inside the interior cavity of housing 18.

First arm 20 may define one or more recesses 20r that may extend inwardly from front end 20c towards rear end 20d or from rear end 20d towards front end 20c, or all of the way from front end 20c through to rear end 20. Recesses 20r may be provided to reduce the overall weight of first arm 20. First arm 20 may also include a layer of padding 42 that may cover some or all of the surfaces on first arm 20 that may contact gun 10 when retained within gun mounting lock 20. As such, padding 42 may cover much or all of interior wall 20b including an interior surface of projection 20g. Padding 42 may extend upwardly over an uppermost end of first upper wall 20e. Padding 42 may terminate on an outer surface of projection 20g a distance above second upper wall 20f. Padding 42 may be secured to the various surfaces of first arm 20 using an adhesive or any other suitable type of fastener.

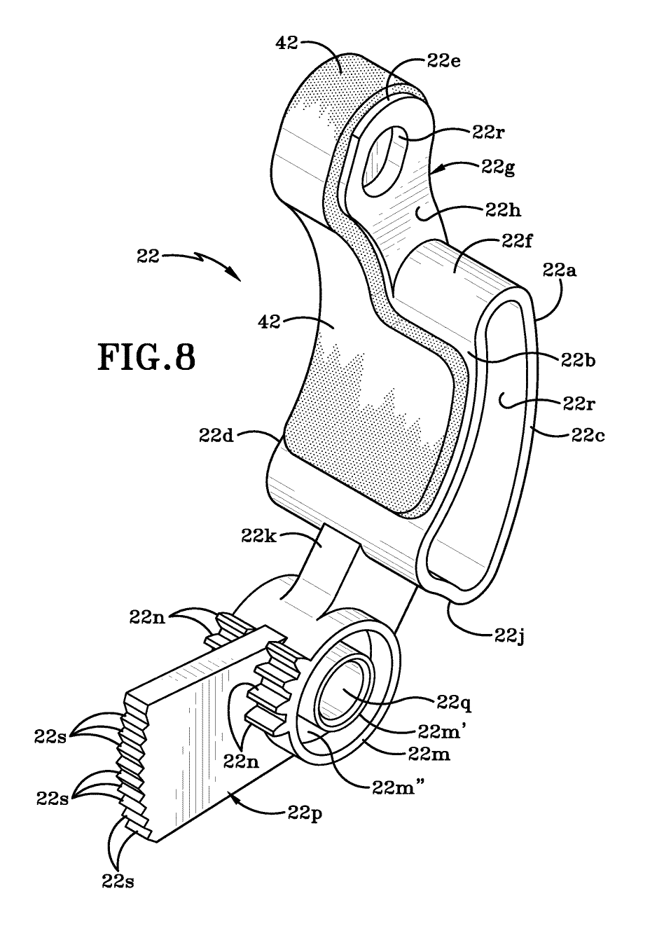

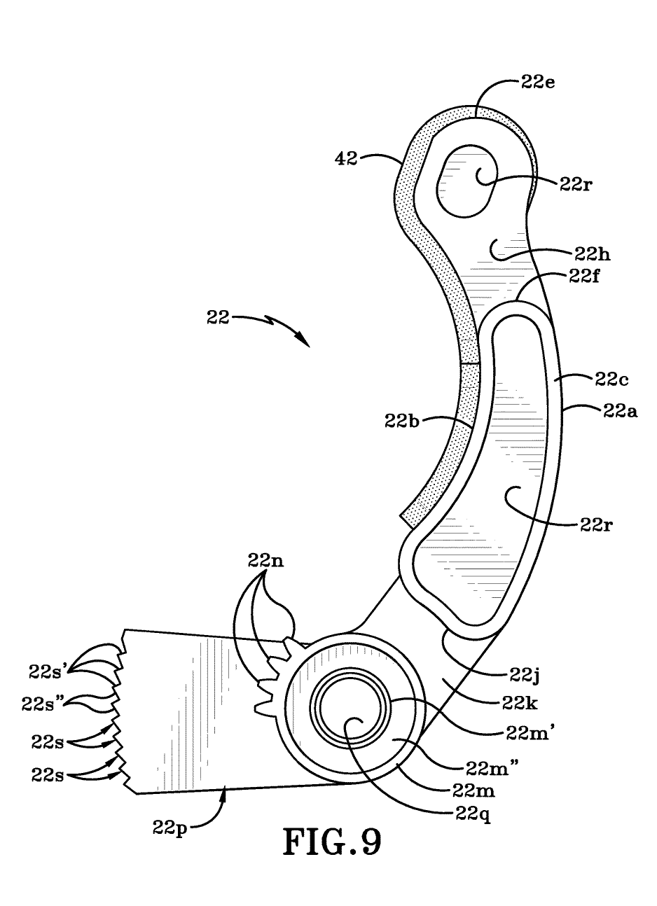

Second arm 22 is shown on its own in FIGS. 8-9. Second arm 22 may be substantially similar to first arm 20 and comprises a body that is generally C-shaped (FIG. 9) when viewed from the front. Second arm 22 has an exterior wall 22a, an interior wall 22b, a front end 22c, and a rear end 22d (FIG. 8). Second arm 22 also includes an upper end comprising a first upper wall 22e and a second upper wall 22f; where the second upper wall 22f is located a distance downwardly from first upper wall 22e. The effect of this is that a projection 22g extends upwardly and outwardly for a distance beyond second upper wall 22f; thereby defining a notch 22h laterally adjacent projection 22g.

Second arm 22 has a lower end that includes lower wall 22j and may have a flange 22k which extends outwardly from lower wall 22j. A hub 22m may be provided at an end of flange 22k. Hub 22m may have a generally circular exterior wall upon which is provided at least one tooth 22n. Hub 22m may, instead have a row of teeth 22n or may have two or more rows of teeth 22n. If two or more rows are provided, then adjacent rows are spaced laterally apart from each other by a gap 22p. The rows of teeth 22n may be provided on that part of hub 22m that faces in the same general direction as interior wall 22b. A smaller diameter hub section 22m′ may be located centrally within the exterior wall of hub 22m and be separated from the exterior wall by an annular ring 22m″. The exterior wall of hub 22m and the hub section 22m′ may be concentric. Hub section 22m′ may define a through-hole 22q that extends from front end 22c through to rear end 22d of second arm 22. Hole 22q is sized to receive a second one of the hubs 30g of first housing section 30 and a second one of the hubs 30h of second housing section 32 therethrough, as is illustrated in FIGS. 19 and 22. The selected second hubs 30g and 32g are positioned so that the apertures 30h and 32h therein are aligned with each other. A fastener 34 is inserted into hole 32h from an exterior surface of end wall 32b and into the threaded hole 30h in first housing section 30. Fastener 34 secures first and second housing sections 30, 32 together and also acts as part of a pivot rod around which second arm 22 may pivot. Second arm 22 is configured to pivot about a longitudinal axis of the shaft of fastener 34. When second arm 22 is engaged within housing 18, flange 22k extends outwardly through the slot in housing 18 that is defined by notches 31b and 33b. This is shown in FIG. 6. The upper end of second arm 22 (including projection 22g is located outside of housing 18 and mounting hub 22m is located inside the interior cavity of housing 18.

Second arm 22 may define one or more recesses 22r that may extend inwardly from front end 22c towards rear end 22d or from rear end 22d towards front end 22c, or all of the way from front end 22c through to rear end 22. Recesses 22r may be provided to reduce the overall weight of second arm 22. Second arm 22 may also include a layer of padding 42 that may cover some or all of the surfaces on second arm 22 that may contact gun 10 when retained within gun mounting lock 12. As such, padding 42 may cover much or all of interior wall 22b including an interior surface of projection 22g. Padding 42 may extend upwardly over an uppermost end of first upper wall 22e. Padding 42 may terminate on an outer surface of projection 22g a distance above second upper wall 22f. Padding 42 may be secured to the various surfaces of second arm 22 using an adhesive or any other suitable type of fastener.

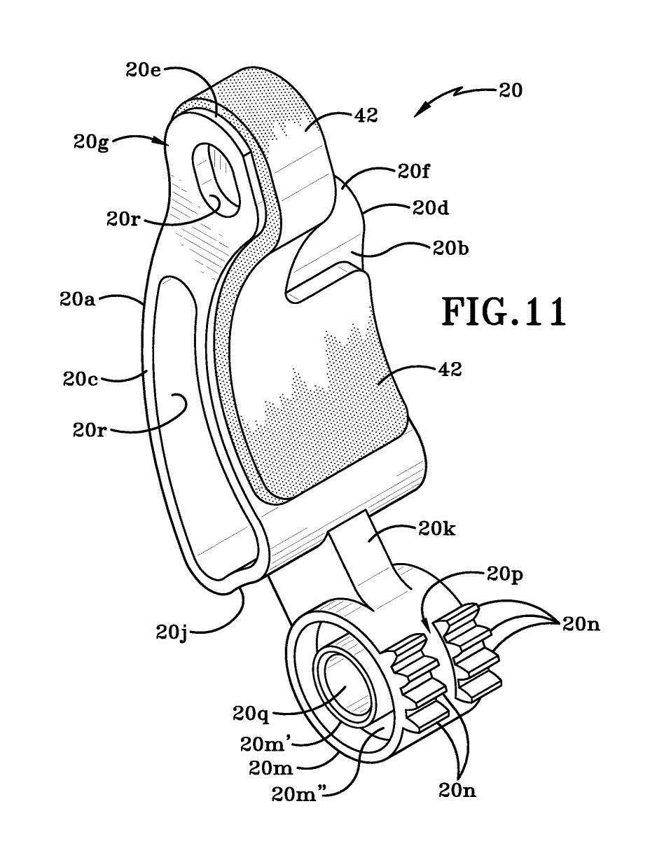

Second arm 22 differs from first arm 20 in that a second flange 22p may extend outwardly from the exterior surface of hub 22m for a distance. Second flange 22p may extend from an area located between two adjacent rows of teeth 22n. A third row of teeth 22s may be provided on an end surface of second flange 22p. The rows of teeth 22n and 22s are provided on that part of hub 22m and second flange 22p that face in the same general direction as interior wall 22b. As is evident from FIGS. 8 and 11, second arm 22 differs from first arm 20 by the provision of second flange 22p between the rows of teeth 22n instead of gap 20p that is present between the rows of teeth 20n.

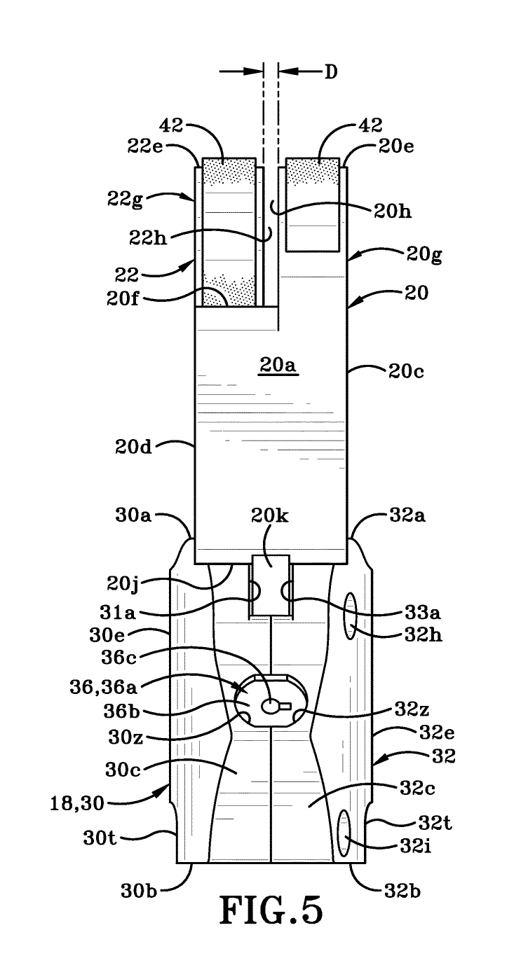

First arm 20 and second arm 22 also differ from each other in the location of the projections 20g, 22g and the notches 20h, 22h. While first and second arms 20, 22 are opposed to each other, the projections 20g, 22g provided thereon and the notches 20h, 20g defined thereby are offset relative to each other. This can be seen in FIG. 5. FIG. 5 also shows that a rear surface of projection 20g is spaced a distance “D” away from a front surface of projection 22g. Projection 20g on first arm 20 is aligned with notch 22h on second arm 22 and the projection 22g on second arm 22 is aligned with notch 20h on first arm 20. When the first and second arms 20, 22 are moved to a closed position (FIG. 21) projection 20g is received in notch 22h and projection 22g is received in notch 20h. The two arms 20, 22 therefore are able to close like a clam-shell and the projections 20g, 22g and notches 20h, 22h dovetail into engagement with each other.

As shown in FIG. 2, when first and second arms 20, 22 are in the open position (i.e., when gun mounting lock 12 is in an unlocked position and is ready to receive a gun 10 therein) the first and second arms 20, 22 form a generally U-shape and bound and define a generally U-shaped opening 54 between their interior surfaces 20b and 22b. The distance between the interior surfaces 20b, 22b is indicated as the distance “L1”. It should also be noted that the curvature of first arm 20 is mirrored by the curvature of second arm 22, i.e., the two interior surfaces 20b and 22b curve in opposite directions from each other.

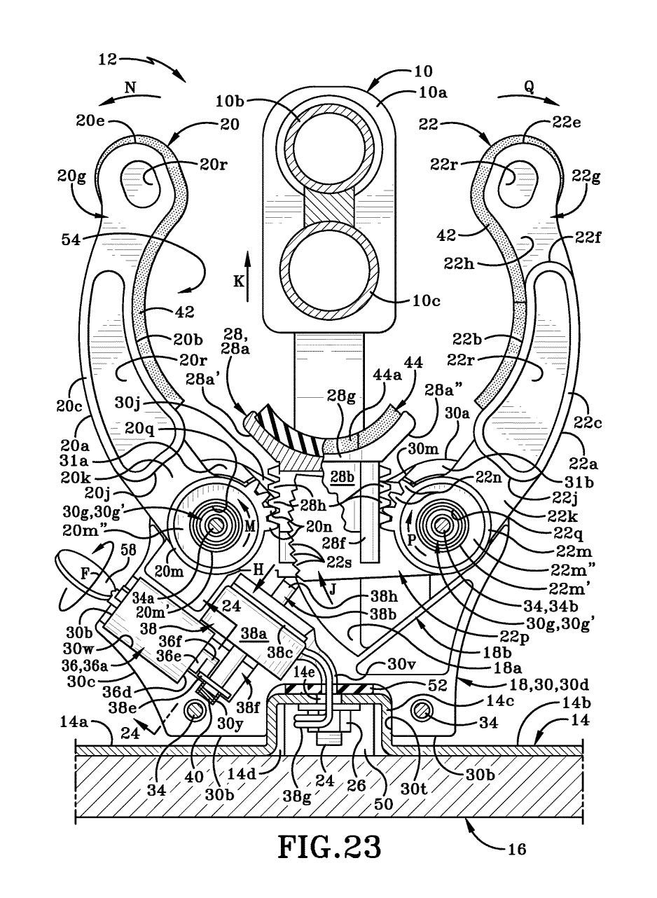

When first and second arms 20, 22 are moved to the closed position (i.e., when a gun 10 is captured within the space defined between the arms 20, 22 as is shown in FIG. 23), the projections 20g and 22g are brought into alignment one behind the other along the same axis when gun mounting lock is viewed from the front. Additionally, the shape of the opening 54 defined between the interior surfaces 20b, 22b is changed from a generally U-shaped opening 54 to a generally elliptically-shaped opening 54′ (FIG. 21). The distance between interior surface 20b and interior surface 22b is reduced to a distance “L2”. Additionally, since the projections 20g, 22g overlap each other, access to opening 54′ from a direction between the two upper ends 20e, 22e is blocked off. The method of pivoting first and second arms 20, 22 between the open position (FIG. 2) and the closed position (FIG. 21) will be further described herein.

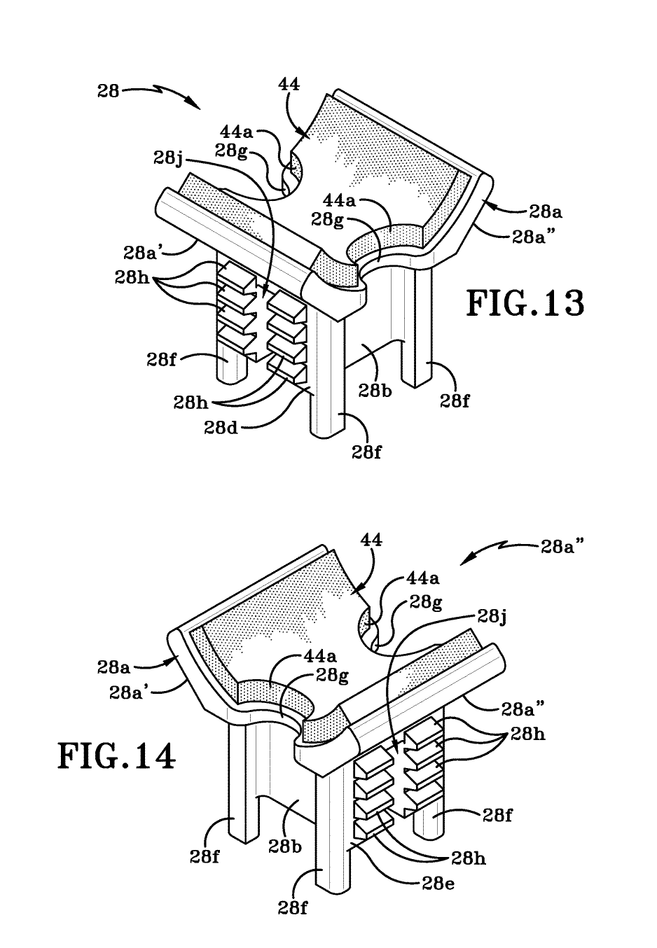

Referring primarily to FIGS. 13-18, ratchet assembly 28 is shown in greater detail. Ratchet assembly 28 is shaped and sized to be received in an opening 18c defined in top wall 30a, 30b of housing 18. Opening 18c is in communication with the interior cavity of housing 18. Ratchet assembly 28 is located between first arm 20 and second arm 22 and ratchet assembly 28, first arm 20 and second arm 22 are located generally along the same axis “X” as is shown in FIG. 3. Ratchet assembly 28 is designed to move linearly up and down relative to the top wall 30a, 30b of housing 18. In other words, ratchet assembly 28 is configured to move along a vertical axis “Y” (FIG. 18) that is oriented at right angles to the axis “X”. First arm 20 and second arm 22 are configured to pivot between a closed position where the projections 20g, 22g thereof are generally aligned along vertical axis “Y” with ratchet assembly 28; and an open position where the projections 20g, 22g are not aligned with ratchet assembly along axis “Y” and are instead located a distance laterally from ratchet assembly 28 and on either side of the axis “Y”.

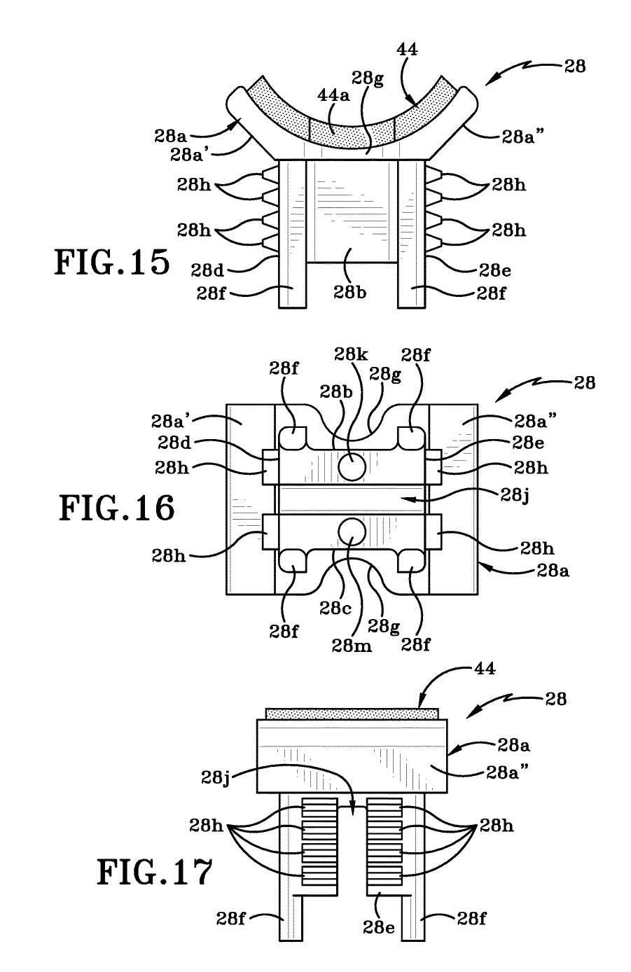

Ratchet assembly 28 comprises a base having a top wall 28a, a first side wall 28b, a second side wall 28c, a first end wall 28d, and a fourth end wall 28e. The side walls 28b, 28c meet the end walls 28d, 28e at corner posts, all of which are indicated by reference character 28f. First and second side walls 28b, 28c and first and second end walls 28d, 28e are recessed relative to posts 28f. Top wall 28a extends for a distance beyond each of the first side wall 28b, second side wall 28c, first end wall 28d and second end wall 28e, and beyond all corner posts 28f. Top wall 28a is concavely curved when viewed from the side (see FIG. 15). The curved shape enables top wall 28a to cradle part of a gun barrel 10b thereon. The lower surface of top wall 28a defines two opposed angled surfaces 28a′ and 28a″. The surfaces 28a′ and 28a″ are shaped and sized to be complementary to angled surfaces 30k/32k and 30m/32m, respectively. When ratchet assembly 28 is moved downwardly in a first direction relative to an upper wall of housing 18 and into the depression 30j, 32j, then the angled surface 28a′ abuts surfaces 30k/32k; and angled surface 28a″ abuts surfaces 30m/32m. Top wall 28a defines a pair of notches 28g in locations proximate first and second side walls 28b, 28c. Padding 44 is applied to an uppermost surface of top wall 28a and the padding 44 also defines a pair of notches 44a therein that are substantially aligned with notches 28g. When a gun barrel 10b is placed on ratchet assembly 28, the barrel 10b will contact padding 44 and be cradled by top wall 28a. (It will be understood that padding 44 may be omitted if desired.)

Each of the first and second side walls 28b, 28c may be substantially smooth along their entire length, width and height. When ratchet assembly 28 is engaged in housing 18, the projections 30n′ and 32n′ are received within one or the other of the recessed regions defined by first side wall 28b and the posts 28f at either end thereof; and second side wall 28c and the posts 28f at either end thereof.

Each of the first and second end walls 28d, 28e may include at least one tooth 28h that extends outwardly therefrom. First and second end walls 28d, 28e may include a row of teeth 28h or two or more spaced apart rows of teeth 28. The rows of teeth 28h may be oriented generally at right angles to top wall 28a. One or both of the first and second end walls 28d, 28e may define a slot 28j therein that is oriented generally at right angles to top wall 28a (FIGS. 16 and 17). At least the one of first and second end walls 28d, 28e that is proximate a lower end of second arm 22 defines slot 28j therein. If two rows of teeth 28h are provided on ratchet assembly 28, then the rows of teeth 28h may flank slot 28j. Slot 28j is sized and shaped to receive second flange 22p of second arm 22 therein. Second flange 22p is located so that when second arm 22 pivots in either of a first direction towards first arm 20 or in a second direction away from second arm 22, second flange 22p will move downwardly or upwardly through slot 28j and into or out of a space 18a defined between projections 30s′ and 32s′ on housing 18. This space 18a may be seen in FIG. 18. Second flange 22p may therefore move through an arc toward or away from the wall 18b (FIG. 20) during operation of gun mounting lock 12.

FIGS. 16 and 18 show that the base of ratchet assembly 28 defines a pair of apertures 28k, 28m therein, wherein each aperture 28k, 28m is located inwardly from one or the other first side surface 28b or second side surface 28c. When ratchet assembly 28 is engaged in opening 18c of housing 18, aperture 28k is vertically aligned with aperture 30s in first housing section 30 and aperture 28m is vertically aligned with aperture 32s in second housing section 32. A set screw 46 and spring 48 are received in each pair of aligned apertures 28k/30s and 28k/32s. Each set screw 46 is provided to adjust the tension in the associate spring 48. Springs 48 control the rate at which ratchet assembly 28 may be pushed downwardly when a gun 10 is engaged with gun mounting lock 12, as will be described hereafter. Springs 48 also urge ratchet assembly 28 upwardly and therefore assist in returning the ratchet assembly 28 to its initial position (FIG. 2) when gun 10 is removed from gun mounting lock 12.

Referring to FIGS. 18-24, gun mounting lock 12 is operated in the following manner. Padding 52 may positioned in U-shaped channel 30t/32t and then housing 18 is engageable with track 14 by interlocking channel 30t/32t on projection 14c of track 14. Padding 52 may be made of any suitable type of resilient material such as rubber or foam. In particular, padding 52 may be positioned between an uppermost surface of projection 14c of track 14 and the interior surface of U-shaped channel 30t, 32t formed by housing 18. If provided, padding 52 defines openings 52a therein that are aligned with each of the holes 30n′ and 32n′. Mounting screws 24 inserted through holes 30n/30n′ and 32n/32n′ are through the associated openings 52a in padding 52 and into a selected slot 14e of track 14. Nuts 26 are engaged with mounting screws 24 and are finger tightened to keep housing 18 loosely engaged with track 14. Housing 18 is moved relative to track 14 by sliding mounting screws 24 along slot 14e until housing 14 is in a desired position. Nuts 26 are then fully tightened to lock housing 18 and track 14 together.

Wiring 38g extending outwardly from channel 30v/32v of housing 18 is threaded through slot 14e of track 14 either before or after securing housing 18 to track 14. Wiring 38g is connected to power pack 50 (FIG. 1) and power pack 50 is positioned within channel 14d of track 14. Power pack 50 is provided to supply current to solenoid 38. Track 14 is placed on support surface 16 and is secured to support surface 16 by any suitable means.

FIG. 20 shows housing 18 engaged with track 14 and track 14 positioned on support surface 16. FIG. 20 also shows gun mounting lock 12 in an open position with projection 20g of first arm 20 and projection 22g of second arm 22 spaced a distance “L1” away from each other and a U-shaped space 54 defined between first and second arms 20, 22. Space 54 is accessible through an opening defined between projection 20g and projection 22g. FIG. 20 also shows gun mounting lock 12 in an unlocked position with second flange 22p of second arm 22 positioned in an at rest position and located a distance away from surface 18b on first housing section 30, 32. Spring 40 is in an uncompressed state and is urging pin 38b of solenoid 38 into contact with a lower region of teeth 22s on second flange 22p. Pin 38b of solenoid 38 is positioned so that second plate 38d is adjacent leg 36f of barrel lock 36 as shown in FIG. 22. FIG. 20 also shows a lower barrel 10c of a gun 10 cradled on padding 44 of ratchet assembly 28 but no downward force being applied to ratchet assembly 28.

In order to move gun mounting lock 12 from the open and unlocked position (FIG. 20) to the closed and locked position (FIG. 21), a downward force is applied to barrels 10b, 10c of gun 10 in the direction indicated by arrow “A” (FIG. 21). Movement of the gun 10 in the direction “A” causes gun 10 to apply a force to ratchet assembly 28 in the direction of arrow “A” and ratchet assembly 28 moves downwardly within opening 18c of housing 18. It should be noted that as ratchet assembly 28 moves downwardly in the direction of arrow “A”, springs 48 (FIG. 18) become compressed between set screws 46 and the portion of housing 18 that defines depressions 30s, 32s.

As is shown in FIG. 21, teeth 28h on ratchet assembly 28 are interlockingly engaged with teeth 20n and 22n of first and second arms 20, 22. The downward movement of ratchet assembly 28 in the direction of arrow “A” causes teeth 28h to move teeth 20n, 22n downwardly and this in turn causes rotational motion of the hub 20m in the direction of arrow “B”; thereby pivoting first arm 20 in the direction of arrow “C” about an axis that extends along the shaft of fastener 34a. The motion of ratchet assembly 28 and thereby teeth 28h in the direction of arrow “A” also drives teeth 22n downwardly and causes rotation of hub 22m in the direction of arrow “D”. Rotation of hub 22m pivots second arm 22 in the direction of arrow “E” about an axis that extends along the shaft of fastener 34b. It should be noted that the downward linear movement of ratchet assembly 28 in the direction of arrow “A” causes hubs 20m and 22m to rotate inwardly toward each other in the directions “B” and “C”; and thereby causes first and second arms 20, 22 to pivot inwardly towards each other in the direction “D” and “E”. The rotation of hubs 20m and 22m in the direction “B” and “C” occurs substantially simultaneously. Additionally, the rotation of first and second arms 20, 22 occurs substantially simultaneously and the movement is synchronized.

The rotation of first arm 20 and second arm 22 causes the space 54 to be reduced in size to space 54′ as projection 20g on first arm 20 is received into notch 22h and projection 22g on second arm 22 is received into notch 20h. As indicated earlier herein the pivotal motion occurs until projections 20g and 22g are aligned with each other over a generally central region of ratchet assembly 28. In this end position, the projections 20g, 22g of first and second arms 20, 22 are brought into contact with upper barrel 10b of gun, thus locking gun between projections 20g, 22g and padding 44 on ratchet assembly 28.

In addition to first and second arms 20, 22 moving into interlocking engagement with each other as described above, as mounting hub 22m rotates in the direction of arrow “D”, second flange 22p is rotated in unison therewith in the direction indicated by arrow “D” (FIG. 21). The rotation of second flange 22p moves second flange 22p towards surface 18b and also causes teeth 22s on second flange 22p to slide downwardly past upper end 38h of pin 38b of solenoid 38. Teeth 22s each have an upper surface 22s′ (FIG. 9) and a lower surface 22s″ that meet at a tip. The upper and lower surfaces 22s′, 22s″ are differently angled. The lower surfaces 22s″ are angled so that second flange 22p is able to rotate downwardly past upper end 38h of pin 38b of solenoid in the direction of arrow “D”. Spring 40 is slightly compressed as pin 38b is pushed downwardly away from second flange 22p as upper end 38h slides along lower surface 22s″ of each tooth 22s. When upper end 38h of pin 38b passes over the tip of any particular tooth then spring 40 will return to its original uncompressed position and upper end 38h will again begin to slide along the lower surface 22s″ of the adjacent tooth. Rotation of second flange 22p in a direction opposite to arrow “D” is substantially prevented by pin 38b engaging the lower surface 22s″. This is because the angle of the upper surface 22s′ of each tooth is substantially complementary to the angle of the side surface of 38b and, consequently, shaft 38b prevents the teeth 22s from moving in the opposite direction. Spring 40 around pin 38b of solenoid 38 urges pin 38b towards second flange 22p and thereby aids in keeping pin 38b engaged with teeth 22s.

When rotation in the direction “D” ceases because first and second arms 20, 22 are interlocked with each other, then gun mounting lock 12 is in a locked position because shaft 38b substantially prevents rotation of second flange 28p in a direction opposite to direction “D”. Since teeth 20n and 22n on mounting hubs 20m, 22m are interlocked with teeth 28h on ratchet assembly 28, first and second arms 20, 22 cannot pivot in the directions opposite to arrows “C” and “E” and ratchet assembly 28 cannot move upwardly in a direction opposite to arrow “A”.

It should also be noted from FIG. 21 that first and second arms 20, 22 are in the closed position capturing gun barrels 10b, 10c between projections 20g, 22g and padding 44 when gun mounting lock 12 is in the locked position. Consequently, gun 10 cannot be disengaged from gun mounting lock 12. Gun mounting lock 12 will remain in the locked position until the user unlocks the gun mounting lock 12 as will be described hereafter.

If it is desired to remove gun 10 from gun mounting lock 12, the lock 12 must be unlocked and moved from the closed position shown in FIG. 21 to the open, unlocked position shown in FIG. 23. There are two possible ways to unlock gun mounting lock 12. In a first way, a key 58 (FIG. 23) is inserted into barrel lock 36 and is turned or rotated in the direction indicated by the arrow “F”. Rotation of key 58 causes detent 36e and leg 36f to rotate in the direction “G” (FIG. 24). Rotation in the direction of arrow “G” causes leg 36f of barrel lock 36 to apply a downward force to the upper surface of second plate 38e. As a result, second plate 38e is moved downwardly in the direction of arrow “H” (FIGS. 24 and 23). The downward movement of second plate 38e causes a corresponding downward movement of pin 38b in the direction of arrow “H” (FIG. 23). The movement of pin 38b in the direction of arrow “H” withdraws pin 38b away from teeth 22s and breaks contact between pin 38b and teeth 22s of second flange 22p. Once contact is broken, second flange 22p is free to rotate upwardly in the direction indicated by arrow “J” (FIG. 23). Since second flange 22p is no longer locked against movement, ratchet assembly 28 (which is geared to mounting hub 22m) is free to move. Springs 48 (FIG. 18) return to their uncompressed state and as they do this ratchet assembly 28 is moved in the direction indicated by arrow “K” (FIG. 23). Since mounting hub 20m is geared to ratchet assembly 28, mounting hub 20m rotates in the direction of arrow “M” in response to the upward movement of ratchet assembly 28 in the direction of arrow “K”. First arm 20 pivots in the direction indicated by arrow “N” in response to the rotation of mounting hub 20m in the direction “M”. Simultaneously, since mounting hub 22m is geared to ratchet assembly 28, upward movement of ratchet assembly 28 in the direction of arrow “K” causes a rotational response in mounting hub 22m and hub 22m rotates in the direction “P”. Rotation of mounting hub 22m in the direction “P” causes a pivotal response in second arm 22 and second arm 22 pivots in the direction indicated by arrow “Q”. It should be noted that mounting hubs 20m, 22m rotate away from each other in the directions “M” and “P” and first and second arms 20, 22 pivot away from each other in the directions “N” and “Q”. As first and second arms 20, 22 pivot away from each other the opening between the upper ends thereof again becomes accessible and gun 10 may be removed from within space 54.

The other method of unlocking gun mounting lock 12 involves providing power to solenoid 38. This can be done by a user engaging actuator 50a. As power is provided to solenoid 38, pin 38b is physically moved downwardly in the direction indicated by arrow “H” in FIG. 23. This motion withdraws upper end 38h of pin 38b from its contact with teeth 22s on second flange 22. All other motions that follow the breaking of contact between pin 38b and teeth 22s are the same as were described above. It should also be noted that as pin 38b is moved downwardly in the direction of arrow “H” (in both methods of unlocking), spring 40 becomes compressed and first plate 38c is moved towards body 38a of solenoid. When power is cut from power pack 50, spring 40 will return to its uncompressed state (shown in FIG. 20). Since second flange 22p has by this time rotated in the direction “J” and away from surface 18b, pin 38b will no longer lock second flange 22p against motion in the direction of arrow “J” and so gun mounting lock 12 will remain ready and open for replacing gun 10 into the same.

In other instances it may be desirable to reconfigure the manner in which solenoid 38 works so that solenoid 38 keeps pin 38b engaged with teeth 22s on second flange 22p when solenoid 38 is powered. In these instances both solenoid 38 and spring 40 will urge pin 38b into interlocking engagement with teeth 22s when second flange 22p is in the position shown in FIG. 21. The only manner of unlocking gun mounting lock 12 will be to use the key 58 as described above. If there is a power failure then spring 40 will continue to urge pin 38b into engagement with teeth 22s and so gun mounting lock 12 will remain locked until key 58 is used to unlock gun mounting lock 12 in the manner previously described.

It should be understood that in some instances instead of the first and second arms 20, 22 and control arm 28 being mounted on a housing 18 that is then secured to a track 14, housing 18 may be directly secured to a support surface. In other instances housing 18 may itself be omitted and the first and second arms 20, 22, control arm 28, barrel lock 36 and solenoid 40 may all be provided as integral components of the support surface itself. So the arms 20, 22 and ratchet assembly may extend outwardly from apertures in a wall of a gun safe, for example.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration set out herein are an example not limited to the exact details shown or described.

1. A gun mounting lock comprising:
a housing;
a first arm rotatably mounted on the housing;
a second arm rotatably mounted on the housing; wherein the first arm is opposed to the second arm;
a ratchet assembly provided on the housing; said ratchet assembly being operatively engaged with both of the first arm and the second arm; wherein the ratchet assembly is movable relative to the housing and when the ratchet assembly is moved in a first direction the first and second arms pivot in unison towards each other; and when the ratchet assembly is moved in a second direction the first and second arms pivot in unison away from each other.

2. The gun mounting lock as defined in claim 1, wherein the ratchet assembly moves linearly in the first direction or the second direction.

3. The gun mounting lock as defined in claim 1, wherein the first and second arms each have an outer end; and wherein the outer ends are offset relative to each other and align one behind the other when the first and second arms have pivoted toward each other.

4. The gun mounting lock as defined in claim 1, wherein the gun mounting lock is movable between a locked position and an unlocked position; and when in the locked position an outer end of the first arm and an outer end of the second arm are aligned with each other and are aligned along a vertical axis with the ratchet assembly; and when in the unlocked position, the outer ends of the first arm and the second arms are not aligned with each other.

5. The gun mounting lock as defined in claim 1, wherein the ratchet assembly is operatively engaged with gears on the first arm and on the second arm.

6. A gun mounting lock comprising:
a first arm;
a second arm positioned opposite the first arm;
a plunger positioned between a lower end of the first arm and a lower end of the second arm; said plunger being operatively engaged with the lower ends of each of the first and second arms; wherein the plunger is movable in a first direction or a second direction; and when the plunger is moved in the first direction, an outer end of the first arm and an outer end of the second arm are caused to move towards each other; and when the plunger is moved in the second direction, the outer ends of the first and second arms move away from each other.

7. The gun mounting lock as defined in claim 6, wherein the plunger moves linearly in the first direction and in the second direction; and wherein the linear motion of the plunger is translated to rotational motion of the first and second arms.

8. The gun mounting lock as defined in claim 7, wherein the plunger is a ratchet assembly comprising a base having a first side located opposite the lower end of the first arm; and a second side that is located opposite the lower end of the second arm; wherein each of the first and second sides includes one or more ratchet teeth; and wherein the one or more ratchet teeth on the first side operatively engage a first gear on the first arm; and the one or more ratchet teeth on the second side operatively engage a second gear on the second arm.

9. The gun mounting lock as defined in claim 8, wherein the second side of the base defines a slot therein; and wherein a flange extends outwardly from the lower end of the second arm and is received within the slot.

10. The gun mounting lock as defined in claim 9, further comprising a plurality of teeth on a terminal end of the flange.

11. The gun mounting lock as defined in claim 8, wherein the first and second gears rotate towards each other when the ratchet assembly is moved in the first direction; and the first and second gears rotate away from each other when the ratchet assembly is moved in the second direction.

12. The gun mounting lock as defined in claim 7, wherein the first gear on the first arm comprises a first mounting hub provided on the lower end of the first arm and a row of first teeth provided on an exterior surface of the first mounting hub; and wherein the second gear on the second arm comprises a second mounting hub provided on the lower end of the second arm and a row of second teeth provided on an exterior surface of the second mounting hub.

13. The gun mounting lock as defined in claim 8, further comprising a housing; wherein the lower ends of each of the first and second arms and a lower end of the ratchet assembly are received within an interior cavity of the housing; and wherein the ratchet assembly moves upwardly and downwardly relative to an outer wall of the housing.

14. The gun mounting lock as defined in claim 13, further comprising a track adapted to be mounted to a support surface; and wherein the housing is engageable with the track.

15. The gun mounting lock as defined in claim 13, further comprising a solenoid having a pin; and wherein pin permits rotation of the flange in one direction but engages the teeth and prevents rotation of the flange in an opposite direction.

16. The gun mounting lock as defined in claim 15, further comprising a lock provided on the housing; wherein the lock includes a first face that is located on an exterior surface of the housing and is adapted to receive a key therein; and wherein a portion of the lock engages a plate that is connected to the pin of the solenoid; and wherein unlocking of the lock with the key causes the portion of the lock to move the plate and thereby the pin, withdrawing the pin from engagement with the teeth on the flange.

17. The gun mounting lock as defined in claim 15, further comprising a power source connected to the solenoid; and wherein the power source provides current to the solenoid and when powered the solenoid unlocks the gun mounting lock.

18. A method of using a gun mounting lock to secure a gun to a support surface comprising:
providing a gun mounting lock comprising a first arm; a second arm positioned opposite the first arm; and a plunger positioned between and operatively engaged with a lower end of the first arm and a lower end of the second arm;
placing a part of the gun onto an upper surface of the plunger;
applying a downward force on the upper surface of the plunger;
moving the plunger downwardly;
translating a downward motion of the plunger as a result of downward force into a rotational motion of the lower ends of the first arm and the second arm; and wherein the rotational motion includes:
rotating the lower end of the first arm about a first axis;
rotating the lower end of the second arm about a second axis;
pivoting an upper end of the first arm towards an upper end of the second arm;
pivoting the upper end of the second arm toward the upper end of the second arm; and
capturing the part of the gun between the upper ends of the first and second arms and the upper surface of the plunger.

19. The method as defined in claim 18, wherein the steps of rotating the lower ends of the first and second arms occurs simultaneously.

20. The method as defined in claim 18, wherein the steps of pivoting the upper ends of the first and second arms occurs simultaneously.

21. The method as defined in claim 18, further comprising;
receiving a projection on the upper end of the first arm in a notch defined in the upper end of the second arm; and
receiving a projection on the upper end of the second arm in a notch defined in the upper end of the first arm.

22. The method as defined in claim 18, further comprising bringing a projection on the upper end of the first arm into alignment with a projection on the upper end of the second arm.

23. The method as defined in claim 22, further comprising; bringing the projections on the upper ends of the first and second arm into alignment with the plunger.

24. The method as defined in claim 18, wherein the plunger is a ratchet assembly and the method further comprises:
interlocking at least one tooth provided on a surface of the ratchet assembly opposite a mounting hub on the lower end of the first arm with at least one tooth provided on the mounting hub of the first arm; and
interlocking at least one tooth provided on a surface of the ratchet assembly opposite a mounting hub on the lower end of the second arm with at least one tooth provided on the mounting hub of the lower end of the second arm.

25. The method as defined in claim 24, further comprising:
rotating the mounting hub on the first arm toward the mounting hub on the second arm as the ratchet assembly is moved downwardly.

26. The method as defined in claim 24, further comprising:
rotating a flange that extends outwardly from the mounting hub of the second arm in unison with the mounting hub of the second arm;
rotating the mounting hub in one direction as the ratchet assembly is moved downwardly;
interlocking a pin of a solenoid on the gun mounting lock with teeth provided on the flange;
preventing rotation of the flange and thereby the mounting hub on the second arm in an opposite direction; and
locking the gun mounting lock.

27. The method as defined in claim 26, further comprising:
unlocking the gun mounting lock by providing power to the solenoid;
moving the pin of the powered solenoid out of interlocking engagement with the teeth on the flange;
moving the ratchet assembly upwardly;
rotating the lower ends of the first and second arms away from each other in response to the upward movement of the ratchet assembly;
pivoting the first and second arms away from each other in response to the rotation of the lower ends of the first and second arms; and
removing the gun from the ratchet assembly.

28. The method as defined in claim 26, further comprising:
inserting a key into a barrel lock provided on the gun mounting lock;
turning the key;
rotating a leg extending outwardly from the barrel lock;
applying a force with the leg to a plate connected to the pin of the solenoid;
moving the plate and thereby the pin away from the teeth on the flange;
moving the ratchet assembly upwardly;
rotating the lower ends of the first and second arms away from each other in response to the upward movement of the ratchet assembly;
pivoting the first and second arms away from each other in response to the rotation of the lower ends of the first and second arms; and
removing the gun from the ratchet assembly.
